(19) United States
(12) Patent Application Publication
(10) Pub. No.: US 2015/0154301 A1
(43) Pub. Date: Jun. 4, 2015

(54) METHOD AND SYSTEM FOR TESTING SPAM RESULT DETECTION ALGORITHMS

(71) Applicant: Baris Yuksel, New York, NY (US)

(72) Inventor: Baris Yuksel, New York, NY (US)

(73) Assignee: GOOGLE INC., Mountain View, CA (US)

(21) Appl. No.: 13/093,049

(22) Filed: Apr. 25, 2011

(51) Int. Cl. G06F 17/30

(52) U.S. Cl. CPC G06F 17/30867

(57) ABSTRACT

A method and system tests spam result detection algorithms. A query processing server is operable to test one or more spam filtering algorithms by submitting high risk queries for processing. The method and system then track whether the spam filtering algorithms successfully filter spam results from the high risk queries. If spam results are detected within the response to the high risk queries, then the spam filtering algorithms are identified as faulty and appropriate action is taken. The spam filtering algorithms may be tested using high risk queries previously detected by the same algorithms, in order to verify that the algorithms continue to function properly.

### BACKGROUND

One of the primary methods by which users access digital information is via the use of search engines. In addition to traditional internet searches, search engines are also used to find content on local computers, computer networks, particular websites, and the like. Search engines are generally judged by the quality of the search results they supply. To this end, search engines use a variety of different methods and algorithms to index, catalogue, and search the vast amounts of information with which they are presented.

As with most methods of digital communication, search engines must deal with the problem of “spam” results. In the context of a search engine, spam results are generally defined as results that are provided for a commercial purpose but which are not directly related to a query provided by the user. Such spam results often consist of pages populated with multiple key words and phrases designed to artificially inflate page ranking for common search queries. For example, a user may wish to locate a cheap hotel near their destination. Such a user might submit a query of “Cheap Hotel Near City X”. The user likely wishes the query to return a list of local hotels in City X. However, the user might find that the list of search results is populated with links to pages with the titles “Cheap Hotel City X”, “Cheap and Affordable Hotel Deals City X”, “Best Cheap Hotel in City X”. These pages are unlikely to point to a page for a specific hotel. Such queries that are generally found to have a higher than usual likelihood of generating spam results are known as “high risk queries”.

### BRIEF SUMMARY

Embodiments of the method and system for testing spam result detection algorithms are described. A query processing server is operable to test one or more spam filtering algorithms by submitting known high risk queries for processing. The method and system then track whether the spam filtering algorithms detect spam results in a response to the high risk queries. If spam results are detected, then the spam filtering algorithms are identified as faulty and appropriate action is taken. In some aspects, the spam filtering algorithms are tested using high risk queries previously detected by the same algorithms, in order to verify that the algorithms continue to function properly.

In one aspect, the technology comprises a computer-implemented method for testing spam result detection algorithms. The method comprises receiving a first query at a query processing server, identifying the first query as a high risk query using a spam filtering algorithm, storing the first query in a data store, where the data store comprises at least one high risk query, automatically generating a test query using at least one high risk query from the data store, submitting the test query to the query processing server, and determining, using a processor, whether a response generated in response to the test query contains a spam result to test the spam filtering algorithm. The test query may be automatically generated by selecting the high risk query as the test query. In some aspects, the spam filtering algorithm is one of a plurality of spam filtering algorithms, and wherein the particular spam filtering algorithm used to identify the spam result within the first query is associated with the first query within the data store. In some aspects, the method further comprises testing the spam filtering algorithm using the first query as the test query. In some aspects, the method further comprises testing one of the plurality of spam filtering algorithms using a query identified as a high risk query by a different spam filtering algorithm. In some aspects, the method further comprises using the test query to verify the continued functionality of each of the plurality of spam filtering algorithms. In some aspects, the method further comprises generating an audit report of whether at least one of the plurality of spam filtering algorithms identified the test query as generating one or more spam results. In some aspects, the method further comprises identifying a spam filtering algorithm as faulty in response to detecting a spam result in the response to the test query. In some aspects, the method further comprises identifying a spam filtering algorithm as functioning properly in response to failing to detect a spam result in the response to the test query.

Aspects of the technology may further include a processing system for testing spam result detection algorithms. The processing system comprises at least one processor, a spam algorithm test module associated with the at least one processor, and memory for storing data including a data store for storing one or more high risk queries. The memory is coupled to the at least one processor. The spam algorithm test module is configured to retrieve a high risk query from the data store, automatically generate a test query using at least one high risk query, submit the test query to a query processing server, and determine whether a spam filtering algorithm identifies a result generated in response to the test query as a spam result. In some aspects, the processing system further comprises a spam detection module. The spam detection module may be configured to identify one or more high risk queries using one or more spam filtering algorithms, and to store the one or more high risk queries in the data store. In some aspects of the processing system, the spam algorithm test module is further configured to identify a spam filtering algorithm as faulty in response to the detection of one or more spam results in a response to the test query. In some aspects, the spam algorithm test module is further configured to identify a spam filtering algorithm as functioning properly in response to a response to the test query being free of spam results. In some aspects of the processing system, the spam detection module is configured with a plurality of spam filtering algorithms, and the spam filtering algorithm used to identify a particular high risk query is stored with the particular high risk query in the data store.

Another aspect of the technology comprises a non-transitory computer-readable storage medium comprising instructions that, when executed by a computer processor, cause the processor to perform a method for testing spam filtering algorithms. The method comprises receiving a first query at a query processing server, identifying the first query as a high risk query using a spam filtering algorithm, storing the first query in a data store, automatically generating a test query using at least one high risk query from the data store, submitting the test query to the query processing server, and determining whether a response to the test query comprises at least one spam result. The data store comprises at least one high risk query. In another aspect, automatically generating the test query may comprise selecting one of the high risk queries as the test query. In another aspect, the spam filtering algorithm is one of a plurality of spam filtering algorithms, and the algorithm used to identify the first query is associated with the first query within the data store. In yet another aspect, the method further comprises testing the spam filtering algorithm using the first query as the test query. In a further aspect, the method further comprises testing one of the plurality of spam filtering algorithms using a query identified as a high risk query by a different spam filtering algorithm. In some aspects the method further comprises using the test query to verify the continued functionality of each of the plurality of spam filtering algorithms.

### BRIEF DESCRIPTION OF THE DRAWINGS

FIG. 1 is a block diagram an apparatus and system for testing spam result detection algorithms in accordance with aspects of the invention.

FIG. 2 is a block diagram depicting a query processing server in accordance with aspects of the invention.

FIG. 3 is a flow diagram depicting a method for testing spam result detection algorithms in accordance with aspects of the invention.

FIG. 4 is a flow diagram depicting a method for building a high risk query database in accordance with aspects of the present invention.

### DETAILED DESCRIPTION

Embodiments of the invention describe a system and method for testing spam filtering algorithms. A query processing server is operable to test one or more spam filtering algorithms by submitting known high risk queries for processing. The method and system then track whether the spam filtering algorithms detect spam results provided in response to the high risk queries. If spam results are detected, then the spam filtering algorithms are identified as faulty and appropriate action is taken. In some embodiments, the spam filtering algorithms are tested using high risk queries previously detected by the same algorithms, in order to verify that the algorithms continue to function properly.

In general, a query is a text string that is sent to a search algorithm. The search algorithm returns a set of results based upon the query. Queries may also be saved by a query processing server to give users suggestions on popular ways to phrase a query. As with many facets of the Internet, search algorithms deal with the problem of spam. In particular, search engines must take into account sites that attempt to artificially raise their page ranking using embedded key words and phrases. To use the example above, a user searching for “Cheap Hotel in City X” most likely wants to see search results for specific hotels, rather than a set of redirection and referral “middle-man” sites. These sites lower the “signal-to-noise” ratio of the search results, and the overall user experience with the search engine. As such, filtering algorithms have been developed to remove these “noise” or “spam” results from the search results. Search queries that are likely to generate spam results are known as “high risk queries”. These queries typically have some sort of commercial aspect, but the term could generally apply to any query that is substantially likely to generate at least one spam result. As such, any query that has previously generated a spam result could be defined as a high risk query.

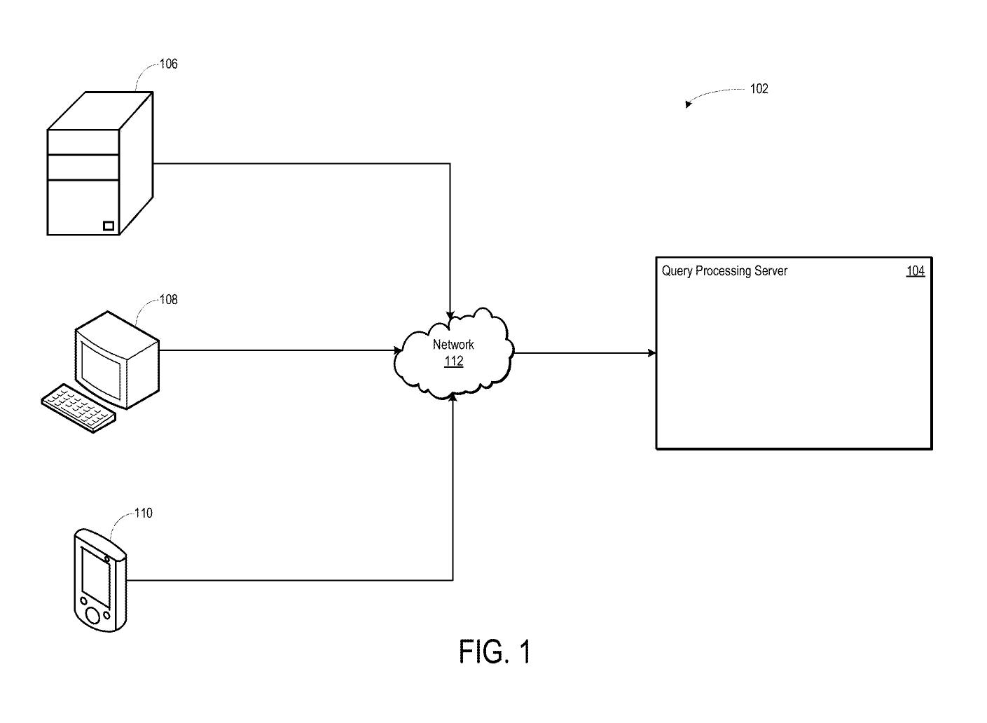

FIG. 1 illustrates one example of a system 102 for testing spam filtering algorithms. The system 102 may include a query processing server 104 in communication with client devices 106-110 via a network 112.

The client devices 106-110 may comprise many different types of client devices, such as an Internet search provider 106, a computer 108, a mobile device 110, a server (not shown), or any other type of computing device operative to provide one or more queries that may include a query to the query processing server 104. For example, the client device may be a computer operated by a user to request a set of search results. The computer displays an interface to allow the user to input a text string. The text string is sent as a query to the query processing server, which generates search results. The search results are then returned to the computer to be displayed to the user. The query processing server 104 may provide one or more search results to the Internet search provider 106 in response to the query. For example, the user may enter a search for “Cheap Hotel in City X” in a search interface displayed on a computer. The search interface forwards the text “Cheap Hotel in City X” to the query processing server 104. The query processing server 104 searches for Internet results relating to the query, and returns a list of sites relating to “Cheap Hotel in City X” to the interface. The results are displayed for the user to select.

In some aspects, the query processing server 104 may act as the search provider itself, and in other aspects the query processing server may function as an intermediary (e.g. to perform initial verification of queries, to perform a search based on a query, to provide results of a query to the desktop computer 108, and the like). As described below, the query results provided to the desktop computer 108 may include one or more Uniform Resource Locations (“URLs”) for one or more websites associated with the query provided by the desktop computer 108. The user may select one or more of the URLs to visit the websites associated with the query results.

The client devices 106-110 may include a mobile device 110, such as a laptop, a smart phone, a Personal Digital Assistant (“PDA”), a tablet computer, or other such mobile device. As with the desktop computer 108, the mobile device 110 may transmit one or more queries to the query processing server 104, such as search queries or navigation queries, and the query processing server 104 may incorporate one or more query results in the response sent to the mobile device 110. For example, a user may use a mobile phone application to send the “Cheap Hotel in City X” text string to a search engine using a search engine application executing on the mobile device. Hence, whether the client devices 106-110 are systems 106 (e.g., Internet search providers, local search providers, social network providers, etc.), desktop computers 108, mobile devices 110 (e.g., laptops, smartphones, PDAs, etc.), the query processing server 104 may be operative to provide one or more query results to the client devices 106-110 based on a initial query.

The network 112 may be implemented as any combination of networks. As examples, the network 112 may be a Wide Area Network (“WAN”), such as the Internet; a Local Area Network (“LAN”); a Personal Area Network (“PAN”), or a combination of WANs, LANs, and PANs. Moreover, the network 112 may involve the use of one or more wired protocols, such as the Simple Object Access Protocol (“SOAP”); wireless protocols, such as 802.11a/b/g/n, Bluetooth, or WiMAX; transport protocols, such as TCP or UDP; an Internet layer protocol, such as IP; application-level protocols, such as HTTP, a combination of any of the aforementioned protocols, or any other type of network protocol now known or later developed.

The query processing server 104 may communicate with the network 112 and client devices 106-110 using one or more interfaces, such as Web Services, SOAP, or Enterprise Service Bus interfaces. Other examples of interfaces include message passing, such as publish/subscribe messaging, shared memory, and remote procedure calls.

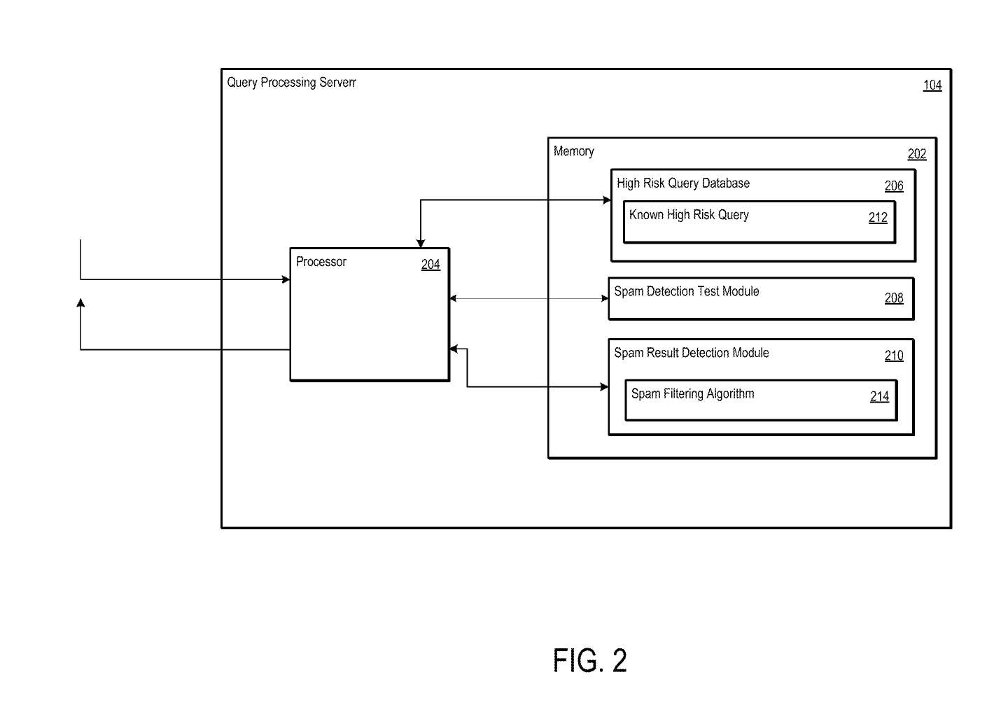

FIG. 2 is one example of the query processing server 104. The query processing server 104 may include a memory 202 in communication with a processor 204. The memory 202 may be operative to store a high risk query database 206, a spam detection test module 208, and a spam result detection module 210.

The high risk query database 206 may store one or more high risk queries 212. The high risk queries 212 are queries that have previously generated spam results that were culled by various detection methods and algorithms. In some embodiments, the high risk queries 212 are manually entered into the system by a user. In some embodiments, the high risk queries 212 may be entered automatically by spam result detection algorithms, such as described below with respect to the spam result detection module 210. The high risk queries 212 may comprise a text string describing the query, a website the query was intended to promote, or a link to the spam result detection method that identified the query.

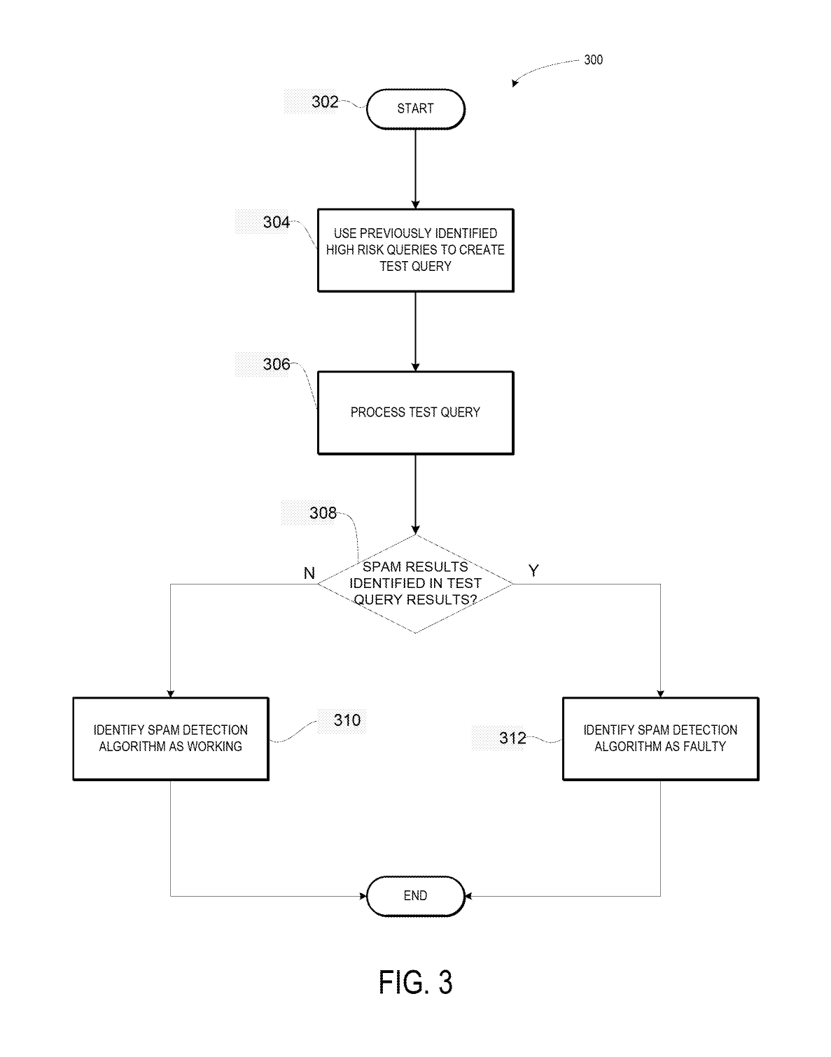

The query processing server 104 may also comprise a spam detection test module 208. The spam detection test module 208 executes methods for verification testing of one or more spam filtering algorithms, such as the spam result detection algorithms 214 discussed below. The spam detection test module 208 ensures that the spam result detection algorithms 214 are properly filtering spam results from high risk queries. In some embodiments, the spam detection test module 208 may determine whether the spam result detection algorithms 214 are functioning by employing a method using high risk queries (See FIG. 3).

The query processing server 104 may further comprise a spam result detection module 210. The spam result detection module 210 operates to detect and filter spam results from results provided by the query processing server 104. In this manner the spam result detection module 210 serves to prevent spam results from being displayed in response to search engine queries, including high risk queries. The spam result detection module 210 may include one or more spam result detection algorithms 214. The spam result detection algorithms 214 represent different methods by which the spam result detection module 210 may determine that a particular result is a spam result. Examples of types of spam result detection algorithms 214 include blacklisting results provided by certain users, blacklisting certain web pages or site addresses, identifying search strings or keywords that are correlated with spam results, and the like. The spam result detection algorithms 214 may be tested by the spam detection test module 208.

The query processing server 104 described above may be implemented in a single system or partitioned across multiple systems. In addition, the memory 202 may be distributed across many different types of computer-readable media. The memory 202 may include random access memory (“RAM”), read-only memory (“ROM”), hard disks, floppy disks, CD-ROMs, flash memory or any other type of computer memory.

The high risk query database 206, the spam detection test module 208, and the spam result detection module 210 may be implemented in a combination of software and hardware. For example, the spam detection test module 208 may be implemented in a computer programming language, such as C# or Java, or any other computer programming language now known or later developed. The spam detection test module 208 may also be implemented in a computer scripting language, such as JavaScript, PEP, ASP, or any other computer scripting language now known or later developed. Furthermore, the spam detection test module 208 may be implemented using a combination of computer programming languages and computer scripting languages. In some aspects, the high risk query database 206, the spam detection test module 208, and the spam result detection module 210 may be implemented on a separate computing node from the query processing server. For example, the system may further include a dedicated hardware firewall used for the purposes of spam detection, through which queries are filtered before reaching the query processing server.

In addition, the query processing server 104 may be implemented with additional, different, or fewer components. As one example, the processor 204 and any other logic or component may be implemented with a microprocessor, a microcontroller, a digital signal processor, an application specific integrated circuit (ASIC), discrete analog or digital circuitry, or a combination of other types of circuits or logic. The high risk query database 206, the spam detection test module 208, and the spam result detection module 210 may be distributed among multiple components, such as among multiple processors and memories, optionally including multiple distributed processing systems.

Processor instructions including algorithms and logic, such as programs, may be combined or split among multiple programs, distributed across several memories and processors, and may be implemented in or as a function library, such as a dynamic link library (DLL) or other shared library. The DLL, for example, may store code that implements functionality for a specific module as noted above. As another example, the DLL may itself provide all or some of the functionality of the system.

The high risk query database 206 may comprise a collection of stored data. For instance, although the high risk query database 206 is not limited by any particular data structure, the high risk query database 206 may be stored in computer registers, as relational databases, flat files, or any other type of database now known or later developed.

The methods below describe computer-implemented methods performed by devices, such as the query processing server 104. These methods generally describe functions that may be performed by a computer processor or processors programmed by software, firmware, or other instructions. Aspects of the methods are generally interchangeable between the query processing server and any separate spam detection computing nodes. As such, it should be understand that language indicating that “the method” performs an action are attributable to the hardware and software performing the method.

FIG. 3 is a flow diagram depicting a method 300 for testing spam result detection algorithms in accordance with aspects of the invention. The method first generates a test query using a data store of high risk queries at step 304. At step 306, the method processes the test query using a spam filtering algorithm. If the results of the test query do not contain spam results, the method identifies the spam filtering algorithm as functional at step 310. If the test query contains spam results, the method identifies the spam filtering algorithm as faulty at step 312.

At step 302, a test of a spam filtering algorithm may be initiated. The test may be initiated on a periodic basis, in response to a user input, in response to a detection of a spam result, as part of a security audit, or in response to any other conditions that might lead to a verification of spam filtering algorithms. At step 304, the method 300 generates a test query using known high risk queries. The method 300 may use one or more high risk queries 212 contained within the high risk query database 206 to generate the test query. For example, the test query might be “Cheap Hotel in City X”, where the test query previously was identified as generating one or more spam results. The test query may be automatically generated from one or more characteristics of the high risk query, such as a particular search term, character string, query topic, or the like. In some aspects, the test query is generated by selecting a known high risk query from the high risk query database 206, and using the selected known high risk query as the test query. In some aspects, the test query is generated as a function of one or more high risk queries, and the one or more high risk queries are processed to generate the test query. For example, if “Cheap Hotel in City X” was the known high risk query, exemplary test queries might be “Cheap Hotel,” “Hotel in City X,” “Cheap Hotel X,” “Cheap Hotel in City X,” “Hotels,” or the like. With the test query generated, the method 300 proceeds to step 306.

At step 306, the method 300 sends the generated test query to the query processing server. For example, the method 300 may forward the test query as if the test query is a legitimate query submitted from a user. Using the cheap hotel example above, the method 300 might send the query to the query processing server in such a manner as to make it appear that the query was received from a user. The query may be processed to generate a set of query results, and then the results processed by the spam result filtering algorithms. After sending the test query to the query processing server, the method 300 proceeds to step 308.

At step 308, the method 300 monitors the test query to determine if the results of the test query contain any spam results. For example, the method 300 may monitor one or more logs generated by the query processing server as the query processing server filters incoming queries. The logs might indicate when a spam result is identified, and would contain output information in response to the test query if the results of the test query are properly detected as including a spam result. The method 300 may monitor the test query using hooks or debug statements included within one or more query processing algorithms, the spam result identification module 210, or any other method of monitoring the spam result detection process. In some aspects, the method 300 may review a set of results received from the query processing server for spam results. Turning again to the hotel example, the method 300 would verify that the query processing server properly generates a set of search results containing only local hotels to City X, and/or sites related to local hotels in City X. In this manner, the system tests whether the algorithms that originally identified the redirection and referral sites as spam results are still functioning properly. The determination may be performed by comparing the original, spam-containing results to the high risk query with results generated after applying a spam-filtering algorithm. If the post-filtering results contain one or more of the original sites that were identified as spam, the algorithm is faulty or otherwise incomplete. If the response to the test query is identified as not containing spam results, the method 300 proceeds to step 310. If the response to the test query contains one or more spam results, the method 300 proceeds to step 312.

At step 310, the query processing server has identified the response to the test query as free of spam results. Since the test query is created using one or more high risk queries, this result indicates that the spam filtering algorithm that processed the high risk query is functioning properly. The method 300 may log the fact the spam filtering algorithm was successful in a results log. The method 300 may return to step 306 to test another spam filtering algorithm. The method 300 may also test each spam filtering algorithm available to the spam result detection module to ensure that all of the algorithms are still functioning properly. The method 300 ends after recording the success of the tested algorithm.

If the query processing server identifies one or more spam results in the results of the test query, the method proceeds to step 312. At step 312, the method 300 records the fact that the tested algorithm failed to filter all spam results from the response to the test query. The method 300 may flag the algorithm as failed in a log file. In some aspects, the method 300 may make a note of the test query and the failed algorithm for review by a user or auditing program. The user or auditing program may then determine why the algorithm failed to identify the spam results generated in response to the test query and adjust the failed algorithm accordingly. The test results may be presented as an audit log or report for review by a system administrator or other user. In some aspects, the algorithm may be automatically tuned to filter the identified spam results in response to the failure. The method 300 ends after recording the failure of the tested algorithm.

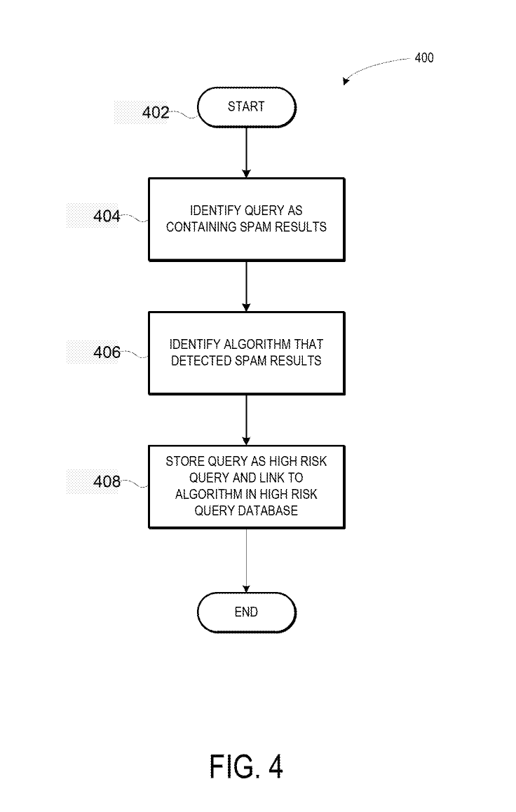

FIG. 4 is a flow diagram depicting a method 400 for building a high risk query database in accordance with aspects of the present invention. The method identifies an incoming query as a high risk query at step 404. At step 406, the method identifies the algorithm that detected the spam results generated in response to the high risk query. At step 408, the high risk query is stored in the high risk query database along with a link to the algorithm that detected the high risk query.

The method 400 begins at step 402 when a query processing server receives a query, and proceeds to step 404. At step 404, the query is identified as a high risk query. For example, one or more results generated in response to the query may be identified as a spam result by a spam result detection algorithm, or the query may be associated with a type of business known for generating spam results. Examples of these spam result detection algorithms include Bayesian filters, commercial intent analysis, string comparison with known spam websites, and the like. After the query is identified as a high risk query, the method 400 proceeds to step 406.

At step 406, the method 400 identifies which algorithm determined that the received query is a high risk query. By identifying the particular algorithm that detected the spam query, a link is established between the particular spam query and the algorithm for later testing. This ensures that the algorithm is still functioning properly when the high risk query is used as a test query with the same algorithm using a method as described above. (See FIG. 3). According to some aspects, the high risk query and a link to the associated algorithm may be stored in the high risk query database 206 for later reference using a test method. (See FIGS. 2 and 3). In some aspects, one or more spam results associated with the high risk query may also be stored in the database for later reference. The identified high risk query and information describing the algorithm that detected the spam results within the high risk query are then stored in the high risk query data base at step 408. The method ends after storing the high risk query and associated data.

Embodiments of the method and system for testing spam result detection algorithms have been described above. A query processing server is operable to test one or more spam filtering algorithms by submitting high risk queries for processing. The method and system may track whether the spam filtering algorithms successfully detect the high risk queries. If the spam results are detected within the results of the high risk query, the spam filtering algorithms that filtered the query results are identified as faulty and appropriate action is taken. In some embodiments, the spam filtering algorithms are tested using high risk queries that were previously identified as containing spam results by the same algorithms, in order to verify that the algorithms continue to function properly.

As described, the system and method provide for the testing of spam result detection algorithms. Since such algorithms may change over time in response to new forms of methods of spam, the system and method advantageously allow a system administrator to verify that the spam filtering algorithms continue to function properly. Storing a repository of high risk queries ensures that a change made to combat a new form of spam does not inadvertently allow an older form of spam to slip through a filtering algorithm.

Although aspects of the invention herein have been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the invention as defined by the appended claims. Furthermore, while certain operations and functions are shown in a specific order, they may be performed in a different order unless it is expressly stated otherwise.

1. A computer-implemented method for testing spam result detection algorithms, the method comprising:
receiving a first query at a query processing server;
identifying the first query as a high risk query using a first spam filtering algorithm;
storing the first query in a data store, wherein the data store comprises at least one high risk query, and wherein the first spam filtering algorithm is associated with the first query within the data store;
generating, based on the association of at least one high risk query from the data store with one or more spam filtering algorithms, a test query using the at least one high risk query;
submitting the test query to the query processing server; and
determining, using a processor, whether a response generated in response to the test query contains a spam result to test a second spam filtering algorithm.

2. The computer-implemented method of claim 1, wherein automatically generating the test query comprises selecting one of the high risk queries from the data store as the test query.

3. (canceled)

4. The computer-implemented method of claim 1, further comprising testing the second spam filtering algorithm using the first query as the test query.

5. (canceled)

6. The computer-implemented method of claim 1, further comprising using the test query to verify the continued functionality of each of the plurality of spam filtering algorithms.

7. The computer-implemented method of claim 1, further comprising generating an audit report of whether at least one of the plurality of spam filtering algorithms identified the test query as generating one or more spam results.

8. The computer-implemented method of claim 1, further comprising identifying a spam filtering algorithm as faulty in response to detecting a spam result in the response to the test query.

9. The computer-implemented method of claim 1, further comprising identifying a spam filtering algorithm as functioning properly in response to failing to detect a spam result in the response to the test query.

10. A processing system for testing spam result detection algorithms, the processing system comprising:
at least one processor;
a spam algorithm test module associated with the at least one processor; and
memory for storing data including a data store for storing one or more high risk queries, each of the high risk queries being associated with at least one spam filtering algorithm, the memory coupled to the at least one processor;
wherein the spam algorithm test module is configured to retrieve a high risk query from the data store based on the high risk query's association with one or more spam filtering algorithms, generate a test query using the one high risk query, submit the test query to a query processing server, and determine whether a tested spam filtering algorithm identifies a result generated in response to the test query as a spam result.

11. The processing system of claim 10, further comprising a spam detection module, the spam detection module configured to identify one or more high risk queries using one or more spam filtering algorithms, and to store the one or more high risk queries in the data store.

12. The processing system of claim 10, wherein the spam algorithm test module is further configured to identify a spam filtering algorithm as faulty in response to the detection of one or more spam results in a response to the test query.

13. The processing system of claim 10, wherein the spam algorithm test module is further configured to identify a spam filtering algorithm as functioning properly in response to a response to the test query being free of spam results.

14. The processing system of claim 11, wherein the spam detection module is configured with a plurality of spam filtering algorithms, and wherein the spam filtering algorithm used to identify a particular high risk query is stored with the particular high risk query in the data store.

15. A non-transitory computer-readable storage medium comprising instructions that, when executed by a computer processor, cause the processor to perform a method comprising:
receiving a first query at a query processing server;
identifying the first query as a high risk query using a spam filtering algorithm;
storing the first query and identification of the spam filtering algorithm in a data store, where the data store comprises at least one high risk query;
generating a test query based on at least one high risk query and identified spam filtering algorithm from the data store;
submitting the test query to the query processing server; and
determining whether a response to the test query comprises at least one spam result.

16. The non-transitory computer-readable storage medium of claim 15, wherein automatically generating the test query comprises selecting one of the high risk queries as the test query.

17. The non-transitory computer-readable storage medium of claim 15, wherein the spam filtering algorithm is one of a plurality of spam filtering algorithms, and wherein the algorithm used to identify the first query is associated with the first query within the data store.

18. The non-transitory computer-readable storage medium of claim 17, wherein the method further comprises testing the spam filtering algorithm using the first query as the test query.

19. The non-transitory computer-readable storage medium of claim 17, wherein the method further comprises testing one of the plurality of spam filtering algorithms using a query identified as a high risk query by a different spam filtering algorithm.

20. The non-transitory computer-readable storage medium of claim 17, wherein the instructions further comprise using the test query to verify the continued functionality of each of the plurality of spam filtering algorithms.

21. The computer-implemented method of claim 1, wherein the first spam filtering algorithm and the second spam filtering algorithm are the same.
